(19) United States
(12) Patent Application Publication
(10) Pub. No.: US 2011/0276643 A1
(43) Pub. Date: Nov. 10, 2011

(54) METHOD, SYSTEM, AND APPARATUS FOR CREATING AN ART FORM FROM A DATA STREAM

(76) Inventors: Marc FISCHMAN, New York, NY (US); Gilad Zirkel, Yehud (IL)

(21) Appl. No.: 13/100,969

(22) Filed: May 4, 2011

Related U.S. Application Data
(60) Provisional application No. 61/330,878, filed on May 4, 2010.

(51) Int. Cl. G06K 9/62; G06F 15/16

(52) U.S. Cl. 709/206; 382/209; 382/165

(57) ABSTRACT

Embodiments of the invention provide a system and method for allowing visualization of messages in a data stream, such as a feed of messages from a social network server containing a common element, e.g., a tag. Data items from each message, for example, a profile picture or other visual item associated with a sender of the message, may be used to construct a mosaic of a target picture, thereby producing a piece of artwork from the data stream.

### CROSS REFERENCE TO RELATED APPLICATIONS

This application claims the benefit of U.S. Ser. No. 61/330,878, filed on May 4, 2010, which is incorporated in its entirety herein by reference.

### BACKGROUND OF THE INVENTION

Advancements in computing and networking technologies such as the Internet have enabled development and implementation of various systems, platforms and methods related to social interactions. In particular, since its inception, the Internet has been fundamentally about connecting people. Recent developments and platforms such as social networks enable users to interact en masse in real time, e.g., through transmissions or status updates that may be posted, broadcast, multicast and/or unicast to other users. Such platforms include Twitter®, Facebook®, Myspace®, and other social media platforms.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic block diagram of an exemplary system according to embodiments of the invention;

FIG. 2 schematically depicts a mosaic server according to an embodiment of the invention;

FIG. 3 schematically depicts a data structure according to embodiments of the invention;

FIG. 4 is an exemplary flowchart describing a method of producing a mosaic based on a real time data stream according to embodiments of the invention;

FIG. 5 depicts an example of a finished mosaic as presented to users according to embodiments of the invention; and

FIG. 6 depicts an example of a mosaic-in-progress as presented to users according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time.

Embodiments of the invention may enable creation of an art form based on a real time stream of data. The art form may be any type of art form, such as a visual art form, such as an image, or an audio art form, such as music, or both. For example, the art form may be compendium of image data taken from the real time data stream to form a larger image, known as a mosaic.

In some embodiments, the data stream may be taken or isolated from within a real time data stream, composed of real time data such as submissions or messages, that was submitted to a social network. The submissions may be in the form of any data, such as images, text, sounds or any other data that can be compiled and prepared into an art form.

In one embodiment, the submissions from which the data is extracted to prepare the art form are those that are submitted to a social network, of which there are many and of which Twitter®, Facebook® and Myspace®, as well as others, are only representative examples.

In some embodiments, the invention provides a means to allow users to relate to a target “message” by creating an art form, such as a personalized art form, based on those providing the message, such as advertisers, marketers, promoters, etc. The invention also provides a method to motivate people to actively market a target message. In such an embodiment, the art form may be related to the target message and may be built from data relating to people marketing the target message, such as image, text or sound data. The reward for those doing the marketing is being part of the personalized art form related to the message that the people helped deliver.

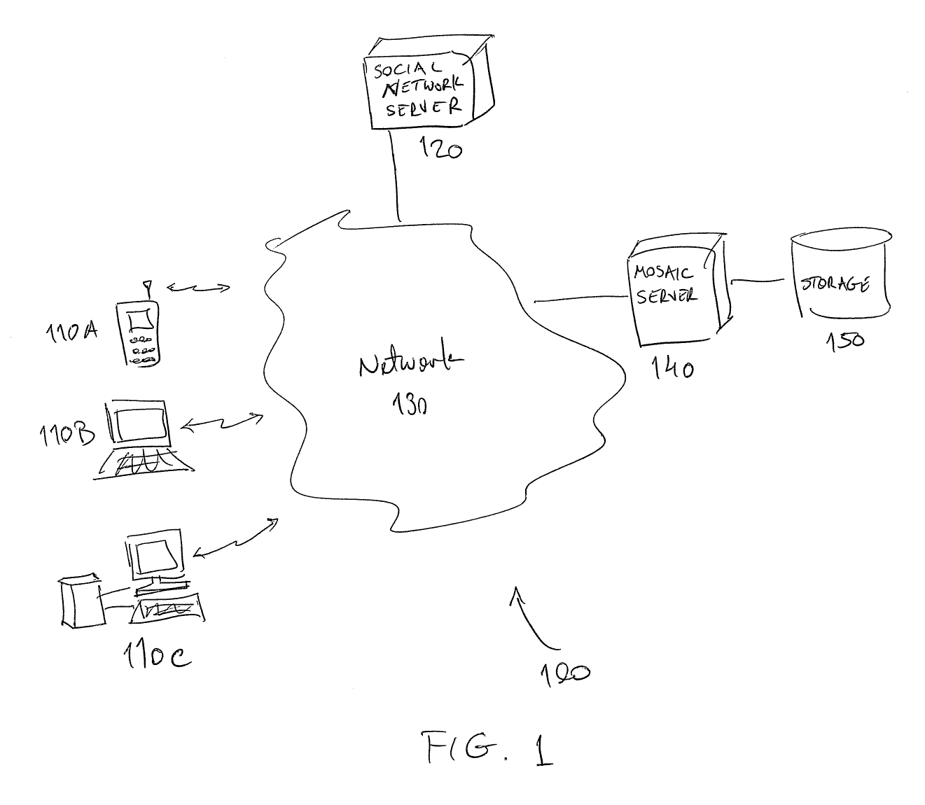

Reference is now made to FIG. 1, which shows a schematic block diagram of an exemplary system 100 according to embodiments of the invention. System 100 may include a plurality of user devices 110A, 110B, 110C, etc., a network 130, a social network server 120, a mosaic server 140, and storage 150. It will be recognized that the servers need not be separate servers, but that their functions may be performed by a single server.

According to embodiments of the present invention, user devices 110 may be client computing devices, e.g., computing devices owned and operated by various remotely located individuals. For example, computing devices 110 may be or may include a personal computer, a desktop computer, a laptop computer, a notebook computer, a terminal, a workstation, a personal digital assistant (PDA) device, a netbook, a smartphone, or any other suitable computing device capable of communicating over network 130. User devices 110 may be equipped with integrated or peripheral input/output devices, e.g., display monitor, keyboard, graphic input module (e.g., mouse, touchpad), etc. In some embodiments, some of user devices 110 may be a mobile or cellular phone, a mobile computer, or any computing device equipped with wireless communication capabilities and/or otherwise capable of wirelessly communicating with other computing devices or networks. For the sake of simplicity, the term “user device 110” may be used herein in singular form. However, it will be understood that user device 110 may refer to one or more of user devices 110. User devices 110 may have communication hardware and software, e.g., a wired or wireless modem for communication with social network server 120 over a network 130.

Network 130 may be, may comprise or may be part of a private or public IP network, or the Internet. Network 130 may be one or a plurality of public or private communication networks. Network 130 may also or in addition, be, comprise or be part of a global system for mobile communications (GSM) network. For example, network 130 may include or comprise an IP network such as the Internet, a GSM related network and any equipment for bridging or otherwise connecting such networks as known in the art. In addition, network 130 may be, may comprise or be part of an integrated services digital network (ISDN), a public or private data network, a local area network (LAN), a metropolitan area network (MAN), a wide area network (WAN), a wireline or wireless network, any combination of the preceding and/or any other suitable communication means. It will be recognized that embodiments of the invention are not limited by the nature, design, type or implementation of network 130, user devices 110, social network server 120, mosaic server 140, and storage 150. For example, these components may be commercial and/or off-the-shelf products as well as specifically designed and/or manufactured components.

Social network server 120 may be any server computer as known in the art, e.g., a web or application server. For example, social network server 120 may be or may include a personal computer, a desktop computer, a workstation, a server computer, a network device and/or any other suitable computing device. Social network server 120 may also be a plurality of servers, for example, operating as a cloud. Social network server 120 may operate a social network service, permitting users to upload various content items in real time using user devices 110, and permitting users to view and obtain content uploaded by others. Examples of social networks may be Twitter®, Facebook®, Myspace®, and others. Social network server 120 may allow users, e.g., human users or application protocol interfaces (APIs), to access and/or perform functions on a stream of data items provided by users. In particular, data items uploaded to social network server 120 may be searched by any number of methods. A search may be any search, e.g., text search, tag search, metadata search, etc., such as a search to extract data or submissions relating to a particular topic or subject. One example is the hashtag (#) function in Twitter®, which allows users to deliberately “tag” their submissions, permitting more efficient search than a simple text search, which may return non-related results. Another example is the tagging function in Flickr®. In another example, users may upload data items or data elements, e.g., images, to a file directory or a user group, which may be retrieved by the mosaic network server 140.

Mosaic network server 140 may be any server computer as known in the art, e.g., a web or application server. For example, mosaic server 140 may be or may include a personal computer, a desktop computer, a workstation, a server computer, a network device and/or any other suitable computing device. Mosaic server 140 may also be a plurality of servers, for example, operating as a cloud.

Storage 150 may be or may include any suitable storage or database as known in the art. Accordingly, storage 150 may enable searching for content and extracting content based on keys, search patterns or any suitable criteria, e.g., as known in the art with relation to databases. Storage 150 may be or may include any commercial database or storage system. In some embodiments, storage 150 may be or may include, for example, a hard disk drive, a Compact Disk (CD) drive, a CD-Recordable (CD-R) drive, or other suitable removable and/or fixed storage unit.

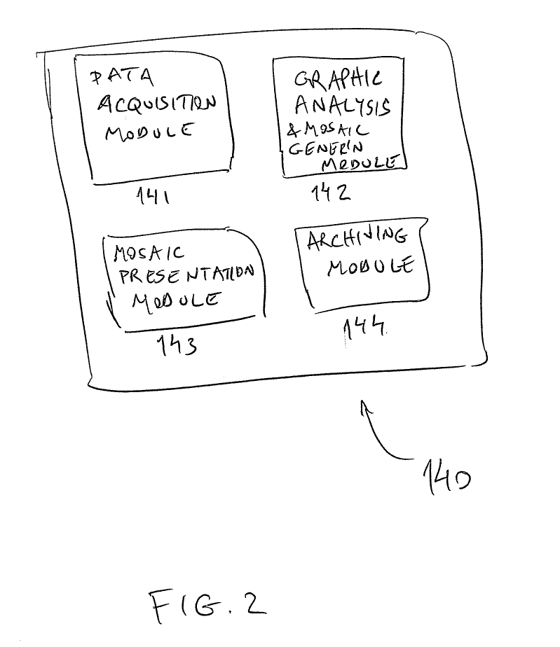

FIG. 2 is a schematic diagram of a mosaic server 140 for producing the art form, in this embodiment, a mosaic, based on a real time data stream. It will be recognized that the modules depicted are schematic in nature, and that the functions may be performed by any suitable software or hardware modules. Data acquisition module 141 may be, for example, an API programmed to obtain a stream of data items, such as from social network server 120. In one example, the data items may be social network user submissions satisfying certain search criteria, e.g., all user submissions on Twitter® (“tweets”) having a certain hashtag parameter. For example, data acquisition module may return all tweets having the string #hashtagart. The search may be further delimited, for example, with a start and end time, etc. The returned data items may include one or more of any sort of data type, e.g., a graphic element, a text element, a universal resource locator (“URL”) reference, etc. The entirety of each retrieved user submission may be stored, for example, in storage 150. The search may run continuously, returning a data stream of user submissions substantially in real time, as the submissions are made to the social network server 120. Of course, data acquisition module 141 may be an API programmed to obtain any other stream of data items from another data source.

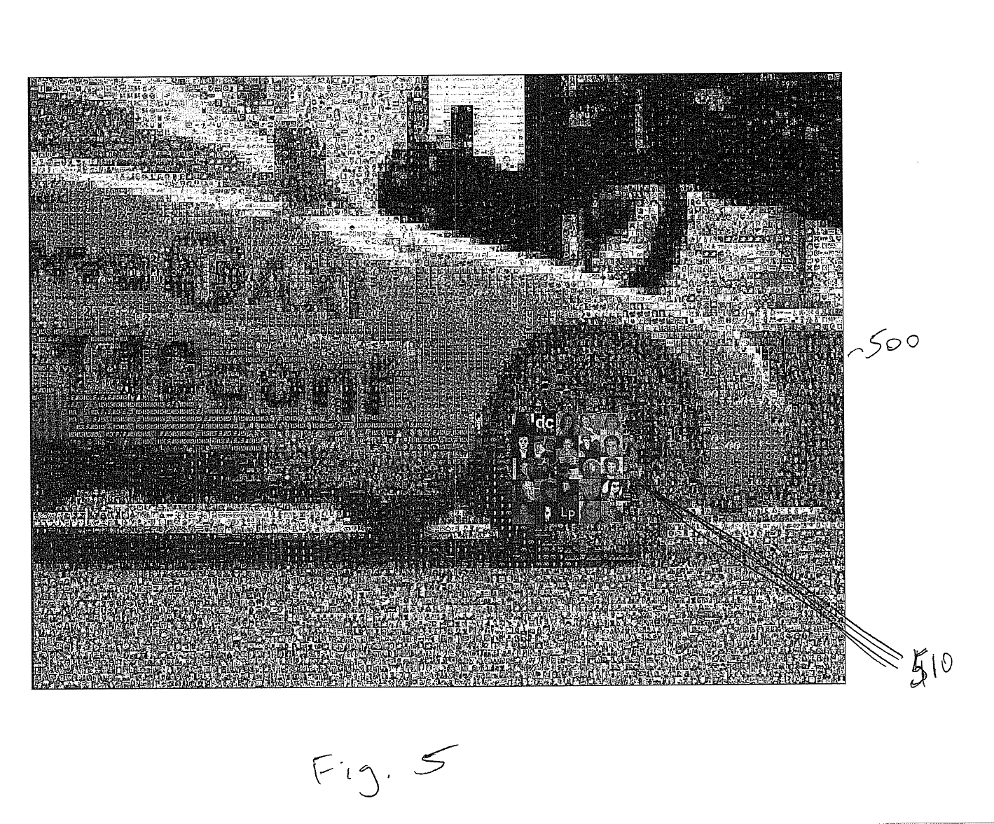

Graphics analysis and mosaic generation module 142 may initiate and populate a position matrix for creation of a mosaic of a particular image based upon the data stream. An object of the mosaic server 140 may be to create a mosaic of a particular image composed of or based on user submissions in a data stream. Thus, for example, a mosaic may be an image to be composed of a plurality of small images, for example, as depicted in FIG. 5. In one example discussed herein, the mosaic may be based on profile pictures of users making submissions, for example, to the social network, or uploaded data, such as images, video or the text of a message. For example, content of user submissions may be used in a certain graphic layout to create an image, using submission images or text to generate the large image, etc. In some embodiments, a combination of images and text may be used to create a target image.

The graphics analysis and mosaic generation module 142 may operate an algorithm substantially as described herein.

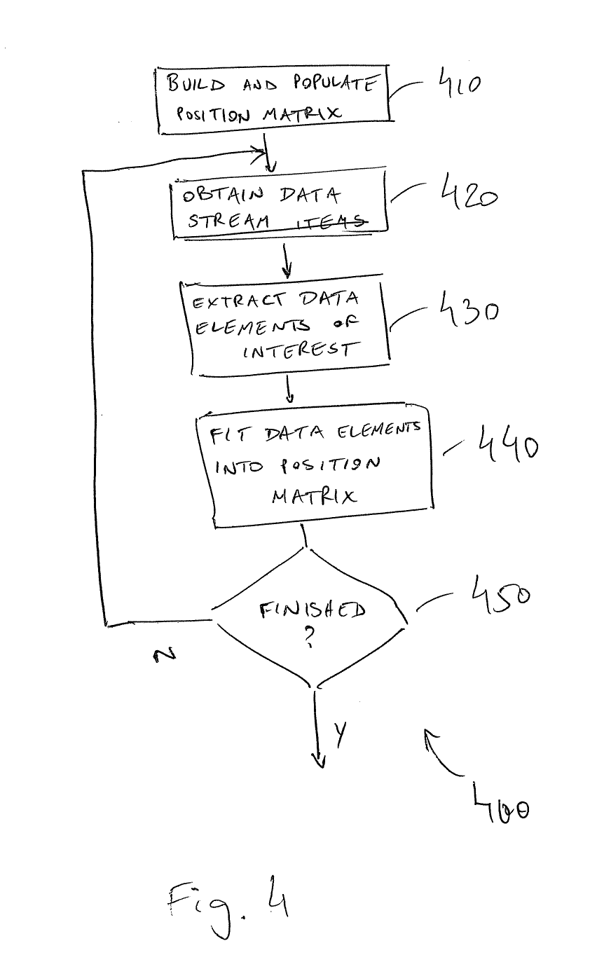

Upon starting a new project or campaign, a target image to be constructed from the data items, or another form of target mosaic, may be provided. A position matrix may be initiated having a number of pixel positions in the source image, the positions including, for example, rows and columns A schematic depiction of the position matrix and the form of records that may represent each position matrix entry is provided in FIG. 4. Other parameters that may be provided upon initiation of the project may include whether to send automatic replies to submitters, the filter search term, e.g., the hashtag, based upon which to select submissions, and the number of positions replaced per unit.

The source image may be divided into a grid of regions (rectangles or other shapes), the grid defined by the width of the image divided by the number of pixels per row. For every region in the grid, the average color of the data in that region may be calculated by the following: (1) for each pixel in the region, the red, green and blue are added respectively to the red sum, green sum and blue sum, and a counter is incremented; (2) after looping through all of the pixels in the region, each color sum is then divided by the counter to obtain the average red, blue and green colors of the region of the source image. For each region, a position is created in the database, in which is stored data elements such as the coordinates from the original source image, the average color of the pixels of that region, and a predefined initial distance, where the “distance” is the difference in color between that data element and the true average color of the pixels of the original source image at that region, e.g., ((0-255)²+(0-255)²+(0-255)²)^{1/2}=442, where 442 is the maximum possible distance, i.e., the worst possible color match. The average color may be stored as a target characteristic for each respective position in the position matrix.

Data items, e.g., user submissions, may be acquired from the social network server 120 as a data stream, and the search may be repeated at predefined time intervals. User submissions may be obtained by any suitable social network user input.

For example, users may interact with a mosaic server to upload messages using social network developer interface tools. A mosaic website may display a mosaic (as described further), and a user arriving at the web page wishing to participate may click a button on or near the mosaic, for example, labeled “Add me”. A form may then be displayed to the user, allowing the user to select which social network to use to add the user, along with the message to be sent. The user may be authenticated according to the social network protocol, and the message entered. The mosaic server may then pull the user data from the selected social network, and use any data item in constructing the mosaic. It will be understood that a third party, e.g., a client advertiser or promoter, may embed code for displaying the mosaic in its website, Facebook® page, etc., such that it appears to views that the mosaic is on the clients server/page, while the content is actually hosted by the mosaic server, or elsewhere.

For example, one option in the “Add me” options may allow the user to select Facebook® connect. A Facebook® connect authentication box may be displayed, asking the user for username and password, and to indicate permission to use Facebook® data, and to post to the user's account. The user may then agree, type a message and click “Post”. The mosaic server may then pull user data from the Facebook® server and submit to the mosaic. The message may also be posted to the social network, for example, by posting on the user's wall that he or she participated in a particular mosaic.

In another example, users may be provided with an option of using Twitter® connect. As described above, a user may contribute by clicking a button on the mosaic titled “Add me”. A form may be displayed allowing to enter a message and select Twitter® as the social network. A Twitter® authentication box may be displayed, asking the user for username and password, and to indicate permission to use Twitter® data, and to post to the user's account. The user may type a message and click “Post”. The user data may be pulled from Twitter® and submitted for inclusion in the mosaic. The message may also be posted to the user's Twitter® account, for example, for dissemination to the user's followers.

In some embodiments of the invention, images may be directly uploaded by a user for placement into the mosaic. For example, users may contribute by clicking a button on the mosaic titled “add me”. A form is displayed which the user is given options on which method to be added to the mosaic, along with the message to be sent. A user may select an image upload checkbox. The user may type a message, select an image from his computer (e.g., using a dialog box to browse and select a file), enter in any additional data (name, email, etc.) and click post. The image may be obtained at the mosaic server, resized, and submitted for placement in the mosaic. The user data may be submitted to the mosaic. After placement of the submitted image in the mosaic, a browsing user clicking on the tile containing an image upload, may see the full image displayed in a lightbox.

Likewise, according to embodiments of the invention, a user may upload a photo stream. In some embodiments, a photo stream may be obtained directly from a camera connected to a network, such as a photo booth, or a camera with a wireless network interface. In some embodiments, a directory on the mosaic server may store images that may be added in batches. Images such as photos, optionally along with any metadata, may be uploaded to the directory. The metadata may be in the photo filename, or a separate metadata file. The mosaic application may detect when photos are added to the directory. It processes each image by resizing it, attaching the meta data, and submitting it to the mosaic. After placement of the images into the mosaic, a browsing user clicking on a tile containing an image, may view the full image displayed in a lightbox.

Some embodiments of the invention may obtain images or videos uploaded as user-generated content on a network, for example, CNN® iReport®. In such an embodiment, users may submit data directly to the network, in the form of images, or videos. The mosaic server may obtain the data stream from the CNN® iReport® server. In the case of videos, a single frame of the video may be extracted and processed for placement in the mosaic. In the case of images, the image may be resized and processed, as described herein. After the submission, a browsing user clicking on a tile containing a video may view the full video played in a lightbox. After the submission, a browsing user clicking on a tile containing an image, may have the full image displayed in a lightbox.

The resulting data stream of items may provide all data items that have not yet been obtained or processed since a previous iteration of the search. For example, in the case of Twitter®, a search may be performed that requests all data items corresponding to a predefined search term. Upon acquisition of new data items from the data stream, the items may be processed as follows: (1) the entire data item may be stored in a database for future reference; (2) a relevant portion of the data item that is determined to be relevant to the art form being created, e.g., the image or other data element to be placed into the mosaic, may be extracted from the data item, and stored in the file system for operation; (3) the extracted data element may be prepared for use in the art form, for example, an image may be resized, in which case a larger image and smaller image may be stored; an image may be cropped to render a uniform shape, etc.; (4) the large image may be stored in a Content Delivery Network (CDN) for quick access during web transmissions or for quick access during display; (5) a task may be initiated to process the colors for each of the incoming images.

The color process task may first obtain the average color of the incoming data element, e.g., image. For each pixel in an image, the red, green, and blue, are added to their respective sums and a counter is incremented. After looping through all of the pixels in the submission image, each color sum is then divided by the counter to return the average red, blue, and green colors of the incoming image.

According to some embodiments of the invention, it may be desirable to ensure that every user who makes a submission may be represented at least once in the resulting mosaic, e.g., regardless of whether the submission is optimally suitable for creation of the mosaic relative to other submissions. For example, in one embodiment, a first submission by every user may be fixed; in other embodiments, other criteria may be used to determine which of a user's multiple submissions may be used as a fixed data element in the mosaic. Accordingly, a determination may be made as to whether the user who submitted the particular data element being treated has previously made a submission. If the data element being processed is the first one for that user, the best available match for the data element in the mosaic (or target canvas), may be found, for example, using the following algorithm: (1) the database (or data structure) may be searched for all available positions; (2) the distance between each available position's color vector and the incoming user data elements' average color vector may be calculated using the following algorithm: ((Rᵤ−Rₚ)²+(Gᵤ−Gₚ)²+(Bᵤ−Bₚ)²)^{1/2}, where u is the user image and p is the available position, and R is the average red content for the user image, G is the average green for the user image, B is the average blue for the user image; (3) the available positions may be sorted starting with the lowest distance; (4) the position in the database with the data matching the image analyzed may be set, although this position may be modified at any time during the campaign if an image from that user with a lower “distance” is found, or the position may be marked in the database as a fixed position, which signifies that it may not be modified at anytime during the campaign; (5) in some embodiments of the invention, the data element may be further be inserted at multiple positions; for example, if the project settings are defined to have pixels replaced per unit (PRPU) as greater than 1, this would allow each user to fill more than one pixel in the mosaic. However, as these positions may not necessarily be marked as fixed, they may be modified in the future of the campaign. (It will be recognized that some embodiments may allow two fixed positions per user, etc.) In the event that PRPU is greater than 1, the incoming image may be compared to each position using the following algorithm: New Distance=((Rᵤ−Rₚ)²+(Gᵤ−Gₚ)²+(Bᵤ−Bₚ)²)^{1/2}. (It will be recognized that for a first insertion at a position, current distance may already be initiated at the start of the project with the maximum distance of 442); (6) data may be selected from the database only where the new distance is less than the current distance, and the data may be sorted by descending order of difference between current distance and new distance; (7) the first PRPU (minus 1 if a fixed position was defined) may be replaced with the new distance; and (8) the position may be updated with the relevant data corresponding to the input unit. If any non-fixed positions were replaced, the positions that were replaced are marked in the database as archived. (It will be recalled that each campaign may start with all positions filled with a distance of 442 by default; in some embodiments of the invention, those empty positions that were preset with a distance of 442 may be set to archived if they are filled by either a fixed or a non-fixed position.); (9) if so configured, an embodiments of the invention may optionally send replies to users making submissions, for example, via social network server 120; a reply may be sent for every submission, or for a first submission, or based on any criterion.

In some embodiments of the invention, a reply may be sent to submitting users. The reply may be sent via the social network server 120. In some embodiments, users may be notified in real time that their submission has been included in the mosaic, and they may be invited to search for their submission in the mosaic. In an embodiment of the invention, the replay may provide users further information, for example, provide a location of a submission in the mosaic. In an embodiment of the invention, a user may be notified of the location of his/her submission in the mosaic. In another embodiment of the invention, a user may not be notified of the location of his/her own submission, but may be notified of the location of another submitting user identified or associated with the user, e.g., a friend on the social network, “follower”, etc. Such other submitting users identified or associated with the user whose submission has been placed in the mosaic may be identified through the particular social network through which the user's data submission was made.

The above process may be repeated. According to embodiments of the invention, the working, e.g, unfinished, mosaic may be displayed to users on an ongoing basis while user submissions are made. The working mosaic may be updated continuously or at predefined intervals, e.g., every 10 seconds, 30 seconds, 1 minute, etc. A mosaic may be regarded as completed when a condition is satisfied, for example, when every position is regarded as fixed. Another condition may be a time condition, e.g., all submissions made by a certain closing time.

In some embodiments of the invention, the mosaic may be filled in more rapidly by using messages to fill in multiple positions. In some embodiments of the invention, one use of the message, for example, the best match, may be indicated in the position matrix as an original use, and therefore, fixed, while other uses of the same message in other positions may be indicated by a data field as being duplicates, and therefore, expendable or replaceable. Accordingly, the duplicate tiles may appear on the working mosaic, but may be considered by the algorithm as available, and therefore may be replaced by data items from other messages, for example, those having a better fit. This may also have the effect of improving the mosaic's resemblance to the target image over time, and draw users to come back repeatedly to view progress on the mosaic.

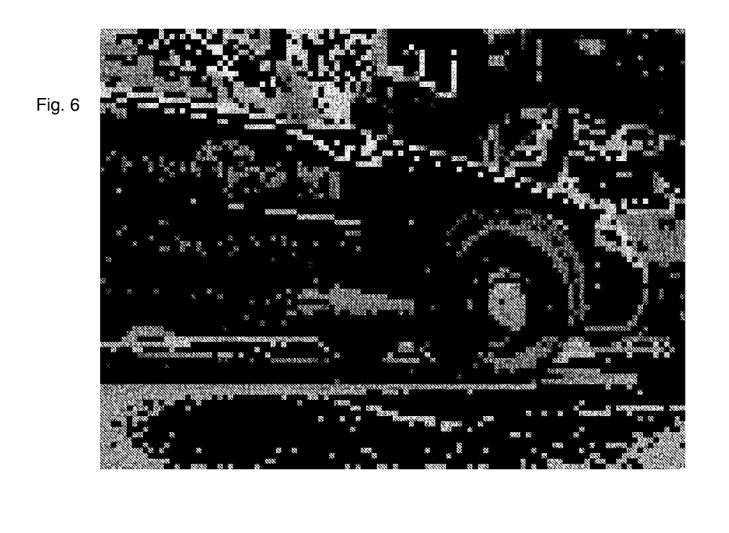

Archiving module 144 may perform a periodic archiving or snapshot function. According to embodiments of the invention, successive working versions of the mosaic may be archived for later playback, for example, to allow users to watch the mosaic take form. In some embodiments of the invention, this may be effected by running a snapshot or archiving function every predetermined time interval. Typically, there may be only one snapshot task running at any given moment during the campaign. First, the previous snapshot that was generated (if one exists) may be obtained. If a previous snapshot does not exist, a blank image, e.g., a solid black color, may be used. This image may be referred to as the canvas. Next, all the positions in the database that were not in any previous snapshot or have been replaced by a closer match may be selected. For every position, the attached input unit image may be taken and added to the canvas at the coordinates of that position. FIG. 6 shows an example of a mosaic-in-progress as presented to users. In some embodiments of the invention, an image may be modified, e.g., by tinting it with the original color of the pixels in the source image. The number of fixed images may be counted, so that the remaining available (e.g., non-fixed) positions available to be filled may be displayed, advising users of how many positions remain available for submissions. The snapshot may be saved, and a snapshot counter of the project may be incremented. In one embodiment of the invention, users may be provided a scroll bar and permitted to view an evolution of the working mosaic by viewing a sequence of snapshots of the mosaic over time.

Mosaic presentation module 143 may be a front end interface module to present the mosaic, e.g, the working mosaic or a finished mosaic, to users. In some embodiments, mosaic presentation module 143 may make a mosaic available to users over a network, e.g., using a website. In other embodiments, mosaic presentation module 143 may render the mosaic on a display, e.g., a large mosaic, such as at a stadium or convention display, or a small mosaic, such as can be viewed on a mobile device, etc. In other embodiments, the mosaic may be a downloaded application with additional features. Mosaic presentation module 143 may allow a user to stand, e.g., with a pointing device, over a portion of the mosaic and view an enlarged version of that portion of the mosaic. In some embodiments, clicking on a portion of the mosaic may cause mosaic presentation module 143 to present other data or metadata associated with the submission, e.g., the username, full-sized or unedited image, submission text, date, time, etc. In one embodiment of the invention, holding the pointer device over a portion of the mosaic may cause presentation module 143 to present an enlarged view of that portion of the mosaic, as derived from the Content Delivery Network (CDN).

In some embodiments of the invention, promotional or other content may be randomly associated with certain tiles, such that the content is “hidden” behind the tiles. For example, coupons, special offers, or other content (e.g., behind-the-scenes footage) may be hidden behind tiles in the mosaic, such that browsing users clicking on the tiles having an the special content hidden underneath can access the coupon, offer, content, etc. Such special tiles may or may not be specially marked as such tiles in the mosaic.

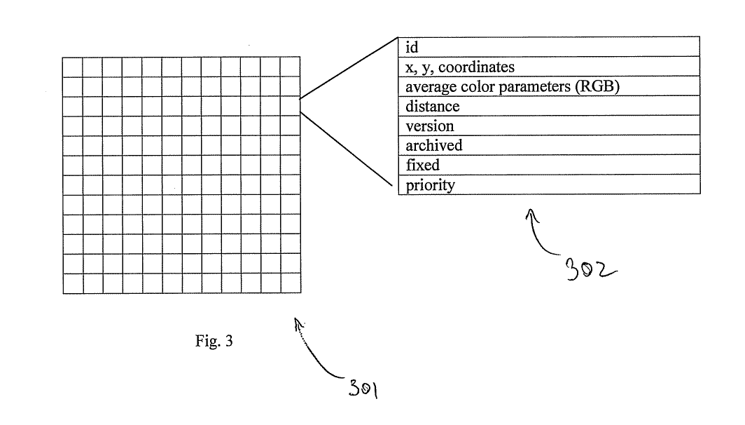

FIG. 3 is a schematic depiction of a position matrix 301 and a template of a single record 302 in a particular position according to embodiments of the invention. It will be recognized that other formats of data structures may be used within the scope of the invention. A record may include fields such as (1) an identification or serial number of the record, which may be a unique number for each position, including distinguishing submissions placed into the same position in different versions or snapshots of the mosaic over time; (2) the x and y coordinates of the position; (3) the average color parameters (RGB) of the data element image; (4) the “distance” of the data element image from the average color parameters of the source image, i.e., the difference of the color of the data element image from the source image pixel color at those coordinates, calculated using the formula identified above; (5) the version or snapshot of the mosaic with which the record is associated or placed; (6) whether or not the data element image has been archived, i.e., whether or not it is within the most current version of the mosaic; (7) whether the position is fixed with a specific data element image; (8) a level or priority of the data element in the position. In instances where a data element is used more than once, for example, at the start of a project, when it is desirable to fill the mosaic rapidly, a single data element may be used in multiple positions, e.g., 20 positions, or 10 positions, etc. This parameter is referred to herein as the PRPU. The greater the PRPU, the more rapidly a mosaic is initially filled in. The data elements filling non-fixed positions may be eventually be replaced by new incoming data elements. The duplicative uses of a data element may be sorted based on a priority level, for example, based on descending rank of distance of the average color parameter vector. Accordingly, the lowest priority duplicates may be replaced first upon receipt of new submissions.

In some embodiments of the invention, data may be gathered and processed during the mosaic campaign to provide the client (e.g., an advertiser using the mosaic as a promotion) with metrics having to do with the success or effectiveness of the campaign. The data collected may include parameters such as, time and/or rate of filling the mosaic, how far the message spread through the network, how many users posted a message to the mosaic, how many friends/followers each user has, etc. From the collected data, the users with greatest influence may be determined, for example, by counting how many followers have posted for each user, which user has the most followers, which user posted the most, etc.

FIG. 4 is a schematic flow diagram of a method 400 in accordance with the present invention. At block 410, a position matrix may be built and populated with initial data. At block 420, data items may be retrieved in real time from a social network server based on a search to obtain a stream of data items. At block 430, a data element of interest in each data item may be extracted from the data item. At block 440, data analysis may be performed, e.g., graphic analysis, to determine the position in the mosaic in which the data element may be appropriately fitted. At block 450, the method may determine based on one or more criteria, whether the mosaic creation is completed, and, if not, the method may loop and repeat blocks 420, 430, 440, and 450 for newly obtained data items.

FIG. 5 is an example of a mosaic 500 produced using an embodiment of the invention. In the example depicted, a pointer standing at location 510 causes the portion to be displayed as enlarged to allow viewing of individual data elements submitted. FIG. 6 shows mosaic 500 in an unfinished state.

Numerous business and commercial applications of the present invention are possible. Advertisers may pay a fee to have their logo included in a certain number of positions as data elements. Advertisers may pay a fee to have coupons included as data elements and challenge users to find the coupon and use a code to obtain a discount on products or services. Other clues or hidden messages may be embedded by sponsors or advertisers, optionally for a fee, and reward provided to first finders of such embedded messages who respond with the hidden information.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein. Some embodiments may be provided in a computer program product that may include a machine-readable medium, having stored thereon instructions, which may be used to program a computer, or other programmable devices, to perform methods as disclosed above. Embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

Unless explicitly stated, the method embodiments described herein are not constrained to a particular order or sequence. Additionally, some of the described method embodiments or elements thereof can occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method comprising:
providing a position matrix comprising an array of positions;
obtaining a plurality of messages having a common element;
matching the obtained messages to respective positions in the position matrix; and
graphically presenting data elements associated with respective obtained messages in association with their respective positions in the position matrix.

2. The method of claim 1, wherein each position in the position matrix is associated with a target characteristic and wherein matching the obtained message to a position in the position matrix comprises matching the obtained message to a position in the position matrix based on a comparison of a feature of the data element to a target characteristic of the position.

3. The method of claim 2, wherein the positions in the position matrix correspond to a target picture, and wherein the target characteristic for each position corresponds to a graphic characteristic of the respective location in the target picture.

4. The method of claim 1, wherein the common element is identified by a common tag contained in the messages.

5. The method of claim 4, wherein the messages are obtained from a social network server.

6. The method of claim 5, wherein obtaining the messages from the social network server comprises obtaining substantially all messages from the social network server having the common tag associated therewith.

7. The method of claim 1, wherein the data element is a graphic element.

8. The method of claim 7, wherein the data element is a profile image of a sender of the associated message.

9. The method of claim 3, wherein the data element is a graphic element and wherein the target characteristic is a target color feature, and wherein matching the obtained messages to respective positions comprises matching the obtained messages to respective positions based on a comparison of a color of the graphic element of the messages to color features of unfilled positions in the position matrix.

10. The method of claim 9, wherein matching the obtained messages to respective positions comprises matching each obtained message to the unfilled position whose target color feature has the least distance to the color of the graphic element of the message.

11. The method of claim 1, further comprising after graphically presenting the data element in association with its respective position in the position matrix, sending a notification to a plurality of senders of the messages.

12. The method of claim 1, wherein the steps of obtaining, matching and graphically presenting are sequentially repeated for each group of said plurality of messages.

13. The method of claim 12, wherein each group comprises a single message.

14. The method of claim 12, wherein each group comprises messages obtained during a predetermined time period.

15. The method of claim 12, wherein the steps of obtaining, matching and graphically presenting are sequentially repeated until a terminal condition is reached.

16. The method of claim 15, wherein the terminal condition is that substantially all positions in the position matrix are identified with respective messages.

17. The method of claim 16, further comprising after satisfying the terminal condition, sending a notification to a plurality of senders of the messages.

18. A server device comprising:
a processor to:
provide a position matrix comprising an array of positions;
obtain a plurality of messages having a common element;
match the obtained messages to respective positions in the position matrix; and
graphically present data elements associated with respective obtained messages in association with their respective positions in the position matrix.

19. The server device of claim 18, wherein each position in the position matrix is associated with a target characteristic and wherein the processor is to match the obtained message to a position in the position matrix by matching the obtained message to a position in the position matrix based on a comparison of a feature of the data element to a target characteristic of the position.

20. The server device of claim 19, wherein the positions in the position matrix correspond to a target picture, and wherein the target characteristic for each position corresponds to a graphic characteristic of the respective location in the target picture.

21. The server device of claim 18, wherein the common element is identified by a common tag contained in the messages.

22. The server device of claim 21, wherein the messages are obtained from a social network server.

23. The server device of claim 22, wherein the processor is to obtain the messages from the social network server by obtaining substantially all messages from the social network server having the common tag associated therewith.

24. The server device of claim 18, wherein the data element is a graphic element.

25. The server device of claim 24, wherein the data element is a profile image of a sender of the associated message.

26. The server device of claim 20, wherein the data element is a graphic element and wherein the target characteristic is a target color feature, and wherein the processor is to match the obtained messages to respective positions by matching the obtained messages to respective positions based on a comparison of a color of the graphic element of the messages to color features of unfilled positions in the position matrix.

27. The server device of claim 26, wherein the processor is to match the obtained messages to respective positions by matching each obtained message to the unfilled position whose target color feature has the least distance to the color of the graphic element of the message.

28. The server device of claim 18, wherein after graphically presenting the data element in association with its respective position in the position matrix, the processor is further to send a notification to a plurality of senders of the messages.

29. The server device of claim 18, wherein the processor is further configured to sequentially repeat the steps of obtaining, matching and graphically presenting for each group of said plurality of messages.

30. The server device of claim 29, wherein each group comprises a single message.

31. The server device of claim 29, wherein each group comprises messages obtained during a predetermined time period.

32. The server device of claim 29, wherein the processor is further configured to sequentially repeat the steps of obtaining, matching and graphically presenting for each group of said plurality of messages until a terminal condition is reached.

33. The server device of claim 32, wherein the terminal condition is that substantially all positions in the position matrix are identified with respective messages.

34. The server device of claim 33, wherein after satisfying the terminal condition, the processor is further configured to send a notification to a plurality of senders of the messages.
